(19) United States
(12) Patent Application Publication
(10) Pub. No.: US 2016/0358123 A1
(43) Pub. Date: Dec. 8, 2016

(54) DIGITIZED POSTAL SERVICE SYSTEM

(71) Applicant: Massimiliano Antonio PANCARI, Sovico (IT)

(72) Inventor: Massimiliano Antonio PANCARI, Sovico (IT)

(21) Appl. No.: 14/761,712

(22) PCT Filed: May 18, 2015
(86) PCT No.: PCT/IT2015/000132

§ 371 Date: Jul. 17, 2015

(30) Foreign Application Priority Data
May 20, 2014 (IT) MI2014A000921

(51) Int. Cl. G06Q 10/08

(52) U.S. Cl. CPC G06Q 10/0832; G06Q 10/0833

(57) ABSTRACT

A digitized postal service system forwards users' correspondence as digital documents using a network over the territory served by postal services. The system includes informatics “server” units which manage the correspondence to and from the users in a geographical area, informatics “router” units capable of interconnecting various server units, and informatics units known as “internal modules” allocated to the site of each user and provided with software and hardware for managing the data. The informatics units include first memories for the registration of correspondence files and a database containing details of the users, a third memory registering a private encrypting/decrypting key reserved for the user of the memory, and software capable of reading from and writing to the memories and formatting the outgoing correspondence. Also included are devices that transfer the correspondence from and to the internal module of each user to and from the relevant server.

The object of this invention is a digitized postal service system.

The advent of informatics technology has generated, in various sectors of a nation's economic and social activities, a progressive and constant transformation and evolution of the traditional modes and processes for the managing of information and the processing of data, while providing considerable advantages in terms of both the extent and rapidity of collecting and spreading the information, as well as of automating and speeding the information and processing of the data.

One of the sectors in which informatics technology has so far made only a partial break-through, but whose future application is necessarily destined to expand is that of postal services, as the dispatch, transmission and delivery of correspondence is still prevalently occurring in a traditional paper-based manner.

The drawbacks often encountered in the traditional modes of handling the postal services are known:
Losses of time in the initial correspondence dispatching phases, phases that necessarily require an access to a public premise with a mailbox for letters or a post office;
Losses of time in the sender's waiting phases in the post offices;
The time needed for shunting and forwarding the correspondence to the addressees, which may also be subject to substantial delays;
The chances of mislaying the letters in a shunting and forwarding phase;
The chances of a missed observance of the confidentiality of the contents of the letters, due to an improper inspection of their contents.

The purpose of this invention is to realize a digitized postal service system capable of allowing, if not a complete transformation of the present paper-based correspondence forwarding modes, at least the beginning of a transitional phase allowing their gradual evolution. The time for starting a transitional phase appears indeed to be ready, when considering the degree of diffusion of computerized devices (PCs, scanners etc.) already attained by many users of postal services.

In particular, the digitized postal service system envisioned here aims to achieve the following advantages:
Drastic savings in the consumption of paper;
Substantial elimination of the spaces allowed to users for the filing of traditional correspondence, and quick and easy traceability of the filed correspondence;
Drastic shortening of the time needed for the dispatching, shunting and forwarding of correspondence, and of its associated costs;
Notable reduction of the potential errors in shunting the correspondence;
Enhanced guarantees, reliability and observance of privacy for both the senders and receivers of correspondence.

For this purpose, the digitized postal services system according to the invention is essentially characterized in claim 1, as formulated below. Preferred forms of implementation are indicated in the depended claims.

The invention will in the following be described in regard to preferred examples of realization of a non-limiting character and while referring to the enclosed drawings which schematically illustrate:

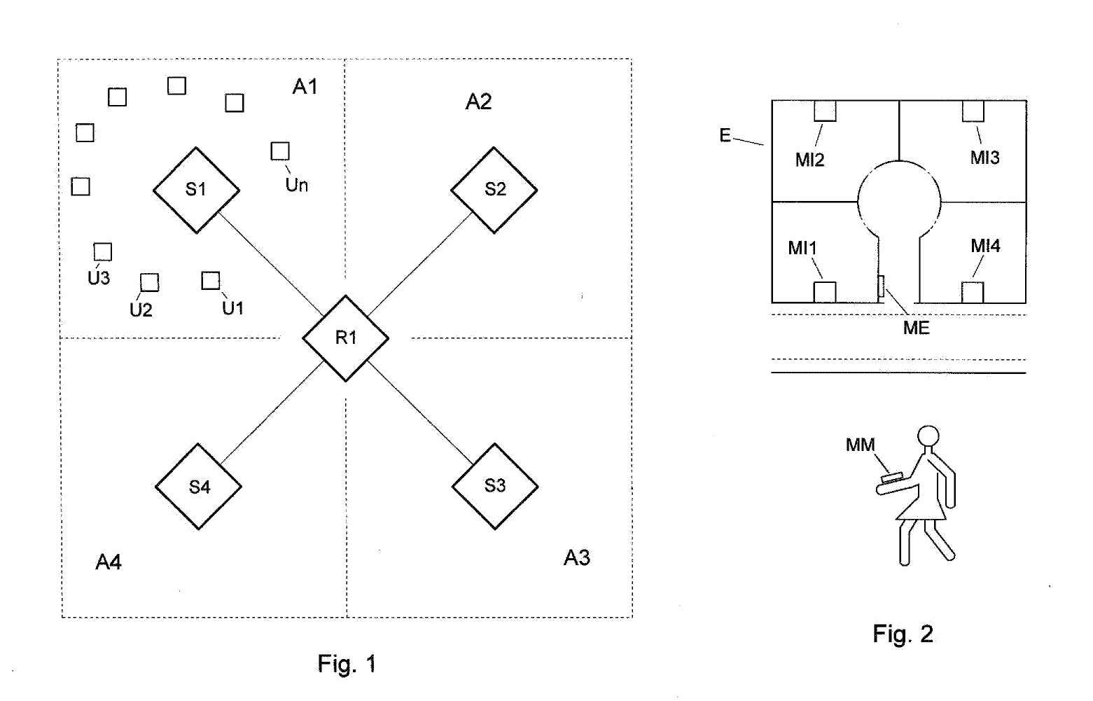

FIG. 1: an example of utilizing a server and external unit for realizing the digitized system according to the invention;

FIG. 2: an example of utilizing internal, external and mobile module units according to the invention.

### DESCRIPTION OF THE PREFERRED REALIZATION EXAMPLES

As schematically shown in FIG. 1, the digitized postal service system according the invention provides that the territory covered by the services be subdivided in various geographical areas (indicated in the figure, for exemplifying purposes, as geographical areas A1, A2, A3, A4), each having a computerized unit known in the following as a “server”, destined for managing the correspondence incoming from and outgoing to the users resident within the same geographical area. In the figure, S1 represents in particular the server destined for managing the correspondence incoming from and outgoing to the users U1, U2, U3 . . . Un resident in the geographic area A1, while S2 S3, S4 represent the servers destined for managing the postal traffic in the areas A2, A3, A4.

In order to allow an exchange of correspondence between the users belonging to different geographical usage areas, provision is made for certain computerized units, known in the following as “externals” and capable of interconnecting various server units. In the figure, R1 represents one of these units capable of interconnecting the servers S1, S2, S3 and S4.

Moreover and as shown in a simplified manner in FIG. 2, the system according to the invention provides for the presence of an informatics unit inside the domicile or site of each user, known in the following as an “internal module”, equipped with hardware and software for handling the data pertaining to the incoming and outgoing correspondence. FIG. 2 shows, for exemplifying purposes, four internal modules MI1, MI2, MI3 and MI4 present at the sites of as many users and allocated to the same building E.

Each internal module MI comprises in particular:
a housing;
an electronic circuit;
at least one inlet and outlet gate, for instance a USB gate, which allows inserting the internal module of the correspondence files to be sent, and/or picking up the correspondence files received;
a first memory for the registration of said correspondence files to be sent and/or of said correspondence files received;
a second memory with the registration of a data base containing the details of all the users availing themselves of the computerized postal service, while said second memory may eventually be allocated to a user's PC;
a third memory with the registration of a private key for the encrypting/decrypting of the documents and the affixing of a digital signature, in the exclusive ownership of the user and differing from each other user, for encrypting the outgoing correspondence and authenticating its origin, and for decrypting the incoming correspondence. Said memory is preferably allocated to a mobile memory support outside said housing and reserved for the same, for instance a pen drive;
a first software capable of inserting and picking up the correspondence into and from the mentioned first memory and emitting a message confirming the reception of the incoming correspondence;
a second software capable of reading the mentioned data base with the details of all the users, of formatting the outgoing correspondence, in particular of allowing the insertion of the consignee's address and the sender's identifying and authenticating message, of affixing the digital signature while using the mentioned encrypting/decrypting key and of encrypting the contents of the correspondence, as well as of being capable of decrypting the incoming correspondence while using the mentioned key and preferably residing inside a user's PC.

In accordance with a preferred solution, said second software utilizes an RSA algorithm for an asymmetrical encryption that provides, in addition to the mentioned private key, for the adoption of a public key characterizing each user and present in the mentioned database containing the details of all users. In a preferred solution, this algorithm is also utilized for generating the digital signature of each user, because each signature is generated in a known manner by a procedure that initially provides for the use of a hash public function for generating a digital imprint (message digest) of the document to be submitted for signature, and subsequently for an encryption of said imprint.

The system according to the invention also provides for the presence of means that are capable of transferring any correspondence incoming to and outgoing from each user's mentioned internal module to and from the relative server.

According to a first solution, said means capable of transferring the correspondence to and from the relative server are constituted of connections of the internal module MI to a user's PC, and from the same, over the internet, to a website page of the server manager, because the pickup and insertion of the correspondence into said module are handled by a managing program operating in the server.

According to an alternative solution said means, which are capable of transferring the correspondence outgoing and incoming from and to the mentioned internal module of each user to and from the relative server, are constituted of:
a computerized unit, known in the following as an “external module”, which is accessible from the outside of the building wherein each user has his domicile or site, connected to the internal modules present in the same building so as to allow the transit of the correspondence incoming to and outgoing from the mentioned internal modules upon the command of a processing software memorized in the same unit, and capable of allowing the pickup and insertion, from the outside of the building, of the correspondence incoming to/outgoing from said internal modules;
a mobile computerized unit, known in the following as a “mobile module” in possession of a person put in charge, by the manager of postal services, of delivering and picking up the correspondence directed to or issued from said users, which is provided of an internal memory for the storing of correspondence directed to or picked up from said external module and of a data transfer managing software, and is attachable to any external module either by a physical connection, for instance by a USB gate present in the external module, or by a wireless connection.

According to a preferred solution, said mobile module is also fitted with a small thermal printer and/or a graphic tablet.

The modes of transferring the correspondence through the digitized system of the present invention are now described by using the following example of a user Ux planning to send a correspondence to an addressee Uy.

The user will first take care of preparing the documents to be sent (for instance, a letter with attachments) in a digital form in accordance with one of the most widely used formats (for instance, in pdf, doc, jpg etc.) while using the informatics tools in his possession (PC, scanner, etc.). He will moreover, if he intends to bestow a legal validity to the signature of one or more of the documents, take care of digitally signing said documents while taking advantage of the software and encryption key issued to him.

The mentioned software will subsequently, after receiving the user's command to go ahead with the dispatching of the documents, ask the user to enter the data identifying the documents to be transmitted, the identity of the addressee, and the modes of transmission (for instance, by registered correspondence, urgent correspondence), and evidence the necessary amount of postage (which will be picked up from a specific current account or rechargeable credit card) on the screen. After receiving the user's confirmation of the entering command, the software will then process a file of the correspondence to be sent in a format suitable for a transmission by e-correspondence, and preferably, to ensure the confidentiality of the correspondence even in respect to the postal service management, in a form encrypted in an asymmetrical mode using the addressees' public key, wherein the mentioned documents to be sent are associated with the data relating to the addressee's and the sender's identity and the date and mode of transmittal. The user will then take care of copying said file to the memory of his own internal MI dedicated to register the correspondence files.

The transfer of this file to the reference server may occur in accordance with one of the following modes.

In a (first) case in which the user has a particular urgency of transmission (or resides in a territorial ambiance with a limited population density, such as would be unable to ensure a daily frequency of passing of the person in charge of delivering a traditional paper correspondence), the user will connect by internet to a website page of the managing server, and the latter will, by using the specific management program assigned to the server, take care of picking up the correspondence file registered in the memory of the sender's internal MI module.

On the other hand, if the user does not intend to avail himself of the above possibility (second case), the correspondence file will remain stored in the memory of the MI module until the first passing of the person in charge of the delivery of traditional paper correspondence. On the occasion of said passing the person in charge of delivering and picking up the correspondence will then in fact connect the mobile module in his possession to the external module present in the user's building, while at the same time activating the managing software present in this latter module, preferably after the person in charge has been recognized by the reception of a timed password. This software will signal the presence of the outgoing correspondence files present in all the internal modules of the building, including those of the user Ux, and after receiving the eventual Ux user's identifying code and password from the mobile module, take care of unloading the user's outgoing correspondence file stored therein. Once the unloading of the file has occurred, the mobile module will send a message directed to the memory of the Ux user's internal module, confirming the day and hour of the pick-up.

The person in charge of the delivery and pick-up of the correspondence will then continue his service for the other users and at the end, after returning to the site of the router, unload all the picked-up correspondence files that are present in the memory of the mobile module into a specific memory present at the external's site.

In case the user resides in the same area served by the sender, the same server will then take care of unloading the file directed to Uy to a mobile module to be used by the person in charge of the delivery and pick-up of the correspondence during his next work shift.

When in the mentioned next work shift the person in charge of delivering the correspondence moves to the site of the addressee Uy, he will connect the mobile module in his possession to the external module present in the user's building, while simultaneously activating the managing software present in this latter module. The managing software for the transfer of data present in the mobile module will then take care:
of unloading the correspondence file directed to Uy to the internal module of the latter, if the correspondence is not the subject of a registered dispatch, and once the unloading of the file has occurred, the internal module of Uy will send the mobile module a message of reception, confirming the day and time of reception;
if the correspondence is instead of a registered correspondence type, of sending the internal module a message translating itself to a notification to the Uy addressee of an incoming registered letter, and in this case the correspondence will be unloaded to Uy's internal module, after the latter will have affixed his signature to a declaration of reception issued by the thermal printer or present on the graphic tablet issued to the person in charge of delivering the correspondence.

If, in accordance with the preferred solution previously indicated, the correspondence file received by the addressee has been encrypted in an asymmetrical mode by the source, the addressee will be able to read the incoming correspondence after decrypting it by using the software and the encrypting/decrypting key issued to him.

In the event that the addressee does not reside in the same area served by the sender's server, the same server will take care of sending the correspondence file to the external connected to the server that serves the addressee's area. Said external will take care of forwarding the correspondence to this latter server, and the modes of delivering the correspondence may thereafter occur in the manner indicated above.

The digitized system according to the invention has, in the foregoing description, been outlined in its main features.

It is in fact susceptible to additional features, such as for instance:
each server will provide each user with a computerized mailbox accessible to the user, which will store a copy of the correspondence received or sent by the server within a limited lapse of time, (for instance over the past six months).
In the case of dispatching a registered correspondence, the manager of postal services will issue the sender (both by the system according to the invention, as well as by e-mail or sms), a message of reception at the instant of picking up the correspondence, and a message of successful delivery after its delivery; moreover, if the sender's server differs from the addressee's server, the forwarding of the correspondence from one server to the other will preferably occur by the procedure provided for by the rule that regulates the transmission of certified electronic correspondence; a computerized trace of the transmitted receptions will be conserved in the user's box for an established period of time (for instance thirty months).
The postal service manager can send each user, by e-correspondence or sms messages, an advance notice of the expected arrival of a registered or urgent correspondence.
The correction of the internal modules with the external module may be of a physical or wireless type.
Each user's internal module may, inside its enclosure, carry signaling devices of a video (for instance, a led or display) or an audio type (for instance, a buzzer or loudspeaker) capable of signaling the presence of a correspondence (to be sent or picked up) stored in the module awaiting a pick-up on the part of the user or operator in charge of letter delivery; it may also be fitted with an intercommunication system capable of communicating, through the external module, with the operator in charge of letter delivery.
The access to the mobile module and its activation may be protected by safety devices capable of being disabled, for instance by a password, a digital imprint reader, etc.
The mobile module may be fitted with several USB gates, a monitor of a capacitive touch screen type, a bar code reader, etc.
The present correspondence boxes available in the streets for inserting paper-based correspondence may also be equipped with devices (for instance USB gates) for inserting digital correspondence.
Said second software assigned to each internal module may conveniently also be programmed to perform a function capable of issuing a digitally signed (thus legally valid) receipt for the incoming correspondence. Said function provides for the generation (through the “hash” public function) of a digital imprint or “message digest” on the correspondence received and on the subsequent digital signature of the same, made by an encryption effected with the addressee's private key. Said digitally signed imprint (readable through the addressee's public key) may also be valid as a receipt (to be released to the server) for a registered correspondence, and is particularly useful in case of an urgent registered letter. In this case, the server can in fact notify the addressee, by informing him via e-correspondence, of an internet address for picking up the registered letter, and the addressee can, at the instant of picking up the registered letter, also take care of returning the digitally signed imprint of the document, directly online.

1. Digitized postal service system, in which the dispatching of the users' correspondence occurs not in the form of paper-based documents but in the form of digital documents, availing itself of a telemetric network distributed over the territory served by the postal services and characterized by the presence of:
computerized units, known in the following as “servers”, distributed over the territory, each destined for the management of the incoming and outgoing correspondence of the users resident in a certain geographical usage area;
computerized units, known in the following as “routers”, capable of interconnecting various server units so as to allow the exchange of correspondence between users belonging to different geographical usage areas;
computerized units, known in the following as “internal modules”, each allocated inside the domicile or site of each user, equipped with software and hardware for the managing of data and in particular provided with:
at least an inlet and outlet gate, for instance a USB gate, which allows the entering, into the internal module, of the correspondence files to be sent and/or received and to be picked up;
a first memory for the registration of said correspondence files to be sent or of said correspondence files received;
a second memory with a registered data base which contains the details of all the users availing themselves of the digitized postal service, while said second memory may eventually also be allocated in a user's PC;
a third memory with a registered private encrypting/decrypting key reserved to the user and different for each user, for encrypting the outgoing correspondence and/or authenticating its origin, and for decrypting the incoming correspondence, where said memory is preferably allocated in an external memory support reserved to the same, for instance a pen drive;
a first software capable of allowing and managing the entering and picking-up of the correspondence into and from the mentioned first memory and the issuing of a confirming message for the successful reception of the incoming correspondence;
a second software capable of reading the mentioned data base with the details of all the users, of formatting the outgoing correspondence, and in particular of allowing the entering of the addressee's address and of a message for the sender's identification and authentication through the mentioned encrypting/decrypting key, as well as the encrypting of the contents of the correspondence, where said software is also capable of decrypting the incoming correspondence through the mentioned key, and can be housed in a user's PC;
and further characterized by the presence of means capable of transferring the correspondence outgoing and incoming from and to the mentioned internal module of each user to and from the relative server.

2. System as in claim 1, wherein the said means capable of transferring the correspondence outgoing and incoming from and to the mentioned internal module of each user to and from the relative server are constituted of connections to a user's PC and from there, though the internet, to a website page of the server manager, where the picking-up and entering of the correspondence from and to the mentioned module is managed by a managing program depending on the server.

3. System as in claim 1, wherein the same means, capable of transferring to and from the relative server the correspondence outgoing and incoming from and to the mentioned internal module of each user are constituted of:
an informatics unit, known in the following as an “external module”, which is accessible from outside the building in which is present each user's domicile or site, connected to the internal modules present in the same building and capable of allowing, upon the command of a managing software residing in the same unit, the picking-up and entering, from outside the building, of the correspondence outgoing and incoming from and to said internal modules;
a mobile computerized unit, known in the following as a “mobile module”, assigned to a person, put in charge by the manager of postal services, of delivering and picking up the correspondence directed to and emitted by said users, equipped with an internal memory for memorizing the correspondence directed to or picked up from said external module, and a software for the managing of the transfer of data connectible to each external module either through a physical connection, for instance a USB gate present in the external module, or a wireless connection.

4. System as in claim 1, wherein each user is also provided, in addition to the mentioned private key, with a public encrypting key, different for each user, which is capable of an asymmetric encryption and also usable for decrypting the digital signature of the documents, the public key of each user being even present in the mentioned data base that contains the details of all the users.

5. System as in claim 3, wherein said mobile module is also equipped with a small thermal printer and/or graphic tablet.

6. System as in claim 3, characterized by the fact that the access to the mobile module and its handling are protected by safety devices, such as for instance safety devices capable of being deactivated through a password, a digital imprint reader, etc.

7. System as in claim 1, wherein each server provides, at its own site and for each user, an informatics mailbox capable of being consulted by the user, in which a copy of the correspondence sent or received by the user remains stored within a limited time lapse, for instance the past 6 months.

8. System as in claim 1, characterized by the fact that in case of a dispatch of registered correspondence, the manager of postal services sends the sender, at the instant of picking up the correspondence from his internal module, a message of reception, and subsequently, after the delivery of the correspondence, sends the sender a message of successful delivery, and also takes care of storing in the user's mailbox, for a certain time, for instance thirty months, a computerized trace of the receipts transmitted.

9. System as in claim 1, characterized by the fact that the internal module of each user is equipped with video or audio signaling devices, capable of signaling the presence of any correspondence stored in the module while awaiting a pick-up on the part of the user or on the part of the postman operator, and further equipped with a device capable of intercommunicating, through the external module, with the same operator.

10. System as in claim 4, characterized by the fact that said second software takes care, after receiving the user's command to dispatch the digital documents to be transmitted, of elaborating a file of the correspondence to be sent, which has a format suitable for a transmission via e-correspondence and is encrypted in an asymmetrical mode by using the addressee's public key, and in which the documents to be transmitted are aggregated to the data relating to the identity of the addressee and of the sender, as well as to the date and modes of transmission.
